(19) United States
(12) Patent Application Publication
(10) Pub. No.: US 2024/0322488 A1
(43) Pub. Date: Sep. 26, 2024

(54) LEVER CONNECTOR AND CONNECTOR DEVICE

(71) Applicant: SUMITOMO WIRING SYSTEMS, LTD., Mie (JP)

(72) Inventor: Yuta INOUE, Mie (JP)

(21) Appl. No.: 18/600,011

(22) Filed: Mar. 8, 2024

(30) Foreign Application Priority Data
Mar. 22, 2023 (JP) 2023-045950

(51) Int. Cl. H01R 13/629; H01R 12/55; H01R 13/516

(52) U.S. Cl. CPC H01R 13/62938; H01R 13/516; H01R 12/55

(57) ABSTRACT

A connector 10 includes: a housing 20; and a lever 40 attached to the housing 20 in a displaceable manner and configured to attract a mating connector 60 by being displaced from a first position to a second position relative to the housing 20, wherein the housing 20 has a through-hole 26H for passing a cam pin 64 of the mating connector 60 through a cam groove 45 formed in an arm 41 of the lever 40, and the lever 40 is movable from the second position to a third position after moving from first position to the second position relative to the housing 20, and has a protrusion 49 that blocks the through-hole 26H when the lever 40 is at the third position.

### CROSS-REFERENCE TO RELATED APPLICATIONS

This application is based on and claims priority from Japanese Patent Application No. 2023-045950, filed on Mar. 22, 2023, with the Japan Patent Office, the disclosure of which is incorporated herein in its entirety by reference.

### TECHNICAL FIELD

The present disclosure relates to a lever connector and a connector device.

### BACKGROUND

For example, Japanese Patent Laid-open Publication Nos. H05-013129, H11-003743, 2002-231379 and 2018-113266 describe lever connectors with which a connector can be reliably fitted with small operating force by operating a lever. The lever connector described in Japanese Patent Laid-open Publication No. H05-013129 has a male connector and a female connector that can be fitted to each other. The lever is rotatably attached to the female connector. The female connector has a through-hole for guiding a cam pin of the male connector into a cam groove in the lever.

### SUMMARY

In the case of a lever connector such as those described above that is attached to a metal case, there is demand for improving water resistance by making it difficult for water to enter the interior of the connector from the through-hole for passing the cam pin.

The present disclosure aims to provide a lever connector and a connector device that can achieve improved water resistance.

A lever connector of the present disclosure includes: a housing; and a lever attached to the housing in a displaceable manner and configured to attract a mating connector by being displaced from a first position to a second position relative to the housing, wherein the housing has a through-hole for passing a cam pin of the mating connector through a cam groove formed in an arm of the lever, and the lever is movable from the second position to a third position after moving from first position to the second position relative to the housing, and has a protrusion that blocks the through-hole when the lever is at the third position.

A connector device of the present disclosure is a connector device including: the lever connector according to claim 1 or 2; and a metal case to which the mating connector is to be fixed, wherein the mating connector includes a mating housing, and the mating housing has a mating hood that is fittable to the housing, the case has a tubular portion configured to cover an outer face of the mating hood, the housing has a protruding wall covering the tubular portion, and the through-hole is formed in the protruding wall.

According to the present disclosure, it is possible to provide a lever connector and a connector device that can achieve improved water resistance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector device according to Embodiment 1 with a lever located at a second position.

FIG. 2 is an exploded perspective view of the connector device.

FIG. 3 is a cross-sectional view of a connector and a mating connector in a fitted state.

FIG. 4 is a cross-sectional view of the lever located at the second position with the connector and the mating connector in the fitted state.

FIG. 5 is a cross-sectional view of the lever located at a third position with the connector and the mating connector in the fitted state.

FIG. 6 is a cross-sectional view of the lever located at the third position, and is an enlarged cross-sectional view of a lever lock and a lever lock receiver.

### DETAILED DESCRIPTION

In the following detailed description, reference is made to the accompanying

drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

Firstly, embodiments of the present disclosure will be listed and described.

(1) A lever connector of the present disclosure includes: a housing; and a lever attached to the housing in a displaceable manner and configured to attract a mating connector by being displaced from a first position to a second position relative to the housing, wherein the housing has a through-hole for passing a cam pin of the mating connector through a cam groove formed in an arm of the lever, and the lever is movable from the second position to a third position after moving from first position to the second position relative to the housing, and has a protrusion that blocks the through-hole when the lever is at the third position. This configuration can make it difficult for water to enter the through-hole in the cam pin, thus improving water resistance.

(2) In the lever connector described in the above item (1), a direction of the movement from the second position to the third position may be the same as a direction in which the lever connector is fitted to the mating connector, and the protrusion may be located within the through-hole when the lever is at the third position. According to this configuration, the size of the lever connector in the direction in which the lever connector is fitted to the mating connector can be made compact by placing the lever at the third position.

(3) In the lever connector described in the above item (1) or (2), an electric wire cover attached to the housing may further be provided, wherein the electric wire cover may have a cover face covering an electric wire pullout face of the housing, and the lever may block a gap formed in the cover face when the lever is at the third position. This configuration can make it less likely for the electric wire pullout face to be exposed to water, thus improving water resistance.

(4) In the lever connector described in any one of the above items (1) to (3), a guide for guiding the movement from the second position to the third position may further be provided. According to this configuration, the lever moves from the second position to the third position along the guide, and can thus easily move from the second position to the third position.

(5) A connector device of the present disclosure is a connector device including: the lever connector according to claim 1 or 2; and a metal case to which the mating connector is to be fixed, wherein the mating connector includes a mating housing, and the mating housing has a mating hood that is fittable to the housing, the case has a tubular portion configured to cover an outer face of the mating hood, the housing has a protruding wall covering the tubular portion, and the through-hole is formed in the protruding wall. This configuration makes it less likely for the case to be exposed to water by blocking the through-hole with the protrusion, thus preventing water from corroding the case.

### Details of Embodiments of Present Disclosure

A specific example of the lever connector of the present disclosure will be described below with reference to the drawings. Note that the present invention is not limited to these examples but is described by the claims, and is intended to include all modifications made within the meaning and scope equivalent to the claims.

### Embodiment 1

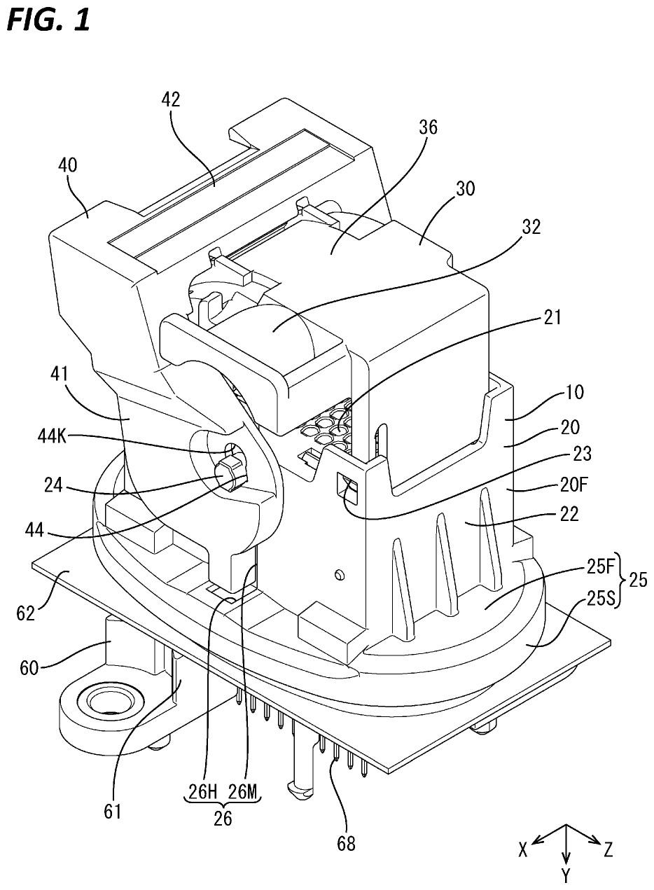

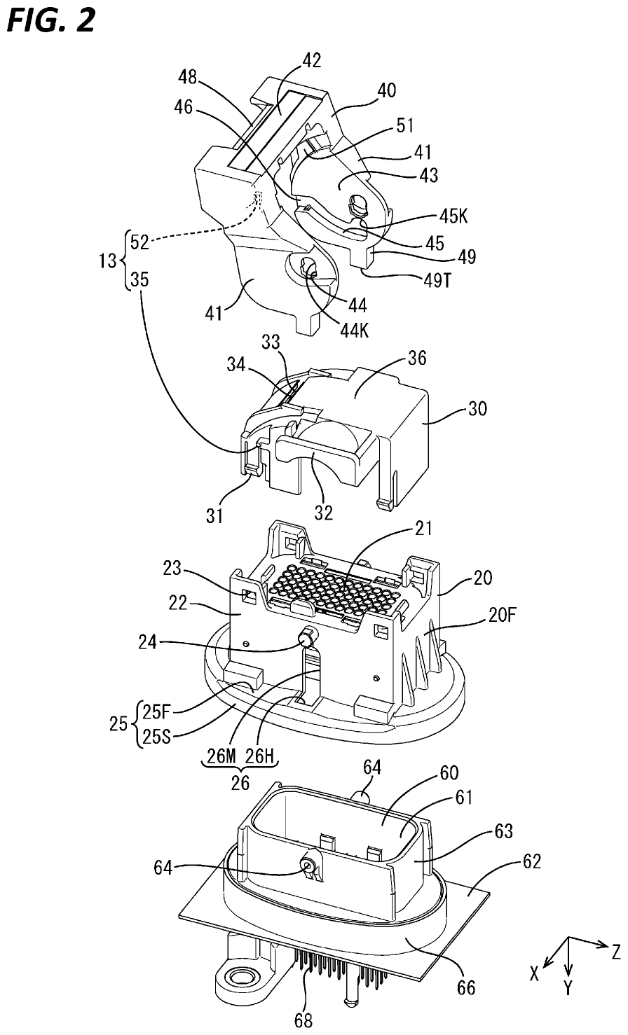

As shown in FIGS. 1 and 2, a lever connector 10 includes a housing 20, an electric wire cover 30, and a lever 40. In the following, the lever connector 10 is referred to simply as a connector 10. The lever 40 is rotatably attached to the housing 20. The lever 40 attracts the connector 10 and the mating connector 60 by rotating from a first position to a second position. When the lever 40 is at the first position, the connector 10 starts being fitted to the mating connector 60. When the lever 40 is at the second position, the connector 10 and the mating connector 60 are in a normally fitted state. A terminal fitting (not shown) of the connector 10 in the normally fitted state are conductively connected to a mating terminal fitting 68.

For each constituent member in the following description, the terms “lower” and “upper” refer to the lower side and the upper side in FIG. 1, respectively. In the figures, positive and negative sides of an X-axis correspond respectively to the right and left sides, the positive and negative sides of a Y-axis correspond respectively to the lower and upper sides, and the positive and negative sides of a Z-axis correspond respectively to the front and rear sides. The Y-axis is parallel with the direction of the fitting between the connector 10 and the mating connector 60. The term “parallel” includes not only a strictly parallel state but also a substantially parallel state.

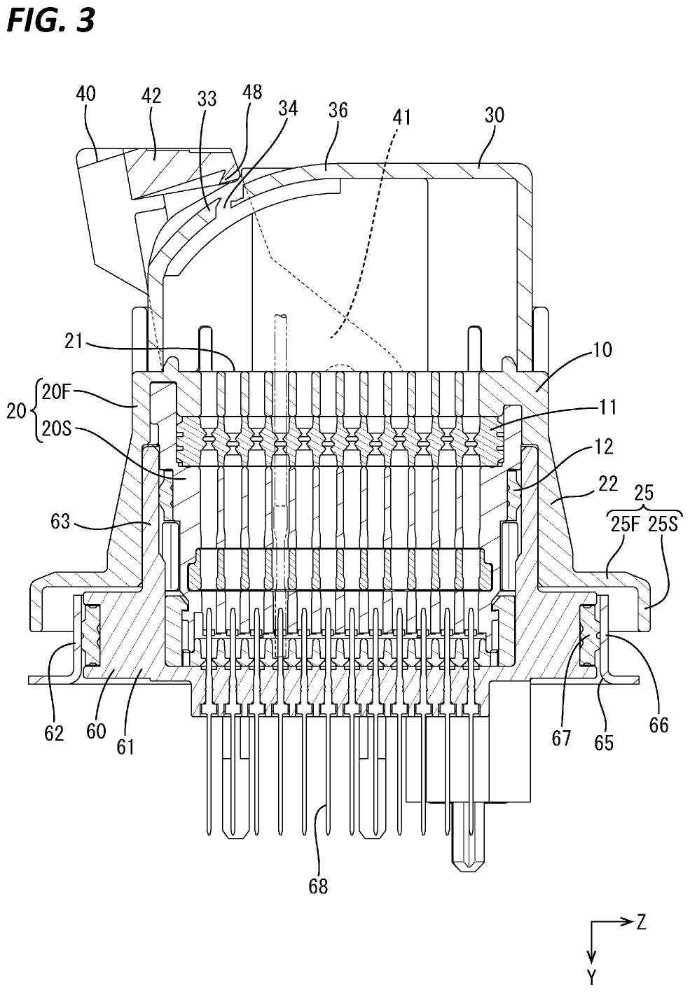

The mating connector 60 is fixed to a case 62, which is made of metal. The drawings show only a part of the case 62. The mating connector 60 includes a mating housing 61, which is made of synthetic resin. The mating housing 61 holds the mating terminal fitting 68. The mating terminal fitting 68 is connected to a circuit board (not shown). The mating housing 61 has a mating hood 63, as shown in FIG. 2. The mating hood 63 has a tubular shape that is open upward. The mating hood 63 has two cam pins 64. The two cam pins 64 protrude from left and right faces of the mating hood 63. The mating hood 63 protrude upward from an opening portion 65 of the case 62, as shown in FIG. 3.

The case 62 is formed by means of aluminum die-casting or the like. The case 62 has a tubular portion 66 that protrudes upward from an entire periphery of the opening portion 65. The tubular portion 66 has an oval shape that is elongated more in the front-rear direction than in the left-right direction. The tubular portion 66 covers a part of an outer face of the mating housing 61. A mating seal member 67 seals a space between the inner face of the tubular portion 66 and the outer face of the mating housing 61.

The housing 20 accommodates a terminal fitting (not shown). The terminal fitting is made of conductive metal. An electric wire (not shown) is connected to a rear end of the terminal fitting. The electric wire is pulled upward from an upper face of the housing 20. The upper face of the housing 20 is an electric wire pullout face 21.

As shown in FIG. 3, the housing 20 includes a first housing 20F and a second housing 20S. The first housing 20F and the second housing 20S are both made of synthetic resin. The first housing 20F has an outer wall 22 and a protruding wall 25. The outer wall 22 has a rectangular tubular shape. The outer wall 22 is fitted to the outer side of the mating hood 63. A plurality of cover lock receivers 23 are provided at a rear end of the outer wall 22, as shown in FIG. 2. Support shafts 24 protrude from left and right faces of the outer wall 22. Each support shaft 24 has a substantially cylindrical shape.

The protruding wall 25 is provided at a lower end of the first housing 20F. The protruding wall 25 protrudes outward from the outer faces of the outer wall 22. The protruding wall 25 has a first wall 25F and a second wall 25S. The first wall 25F protrudes parallel with an XZ plane from the outer faces of the outer wall 22. The outer shape of the first wall 25F when viewed from above is an oval shape conforming to the shape of the tubular portion 66. The second wall 25S protrudes downward from the outer edge of the first wall 25F. The second wall 25S is fitted to the outer side of the tubular portion 66 of the case 62. The second wall 25S covers the outer face of the tubular portion 66.

The first housing 20F has passage portions 26 for passing the cam pins 64, as shown in FIG. 2. The passage portions 26 are formed on the left and right sides of the first housing 20F. The passage portions 26 are provided at the center of the first housing 20F in the front-rear direction.

Each passage portion 26 has a through-hole 26H and a through-groove 26M, as shown in FIG. 2. The through-hole 26H is formed in the protruding wall 25. The through-hole 26H extends in the vertical direction through the first wall 25F of the protruding wall 25. The through-hole 26H has a rectangular shape when viewed from above. The through-groove 26M is formed in the outer wall 22. The through-groove 26M is connected to the through-hole 26H and extends straight upward from the through-hole 26H. The through-groove 26M extends through the outer wall 22 in the inward-outward direction. The support shafts 24 are located immediately above the respective through-grooves 26M.

As shown in FIG. 3, the second housing 20S is accommodated within the first housing 20F. The second housing 20S is an inner housing, and the first housing 20F is an outer housing. A first seal member 11 is disposed between the first housing 20F and the second housing 20S.

The second housing 20S is fitted to the inner side of the mating hood 63. A second seal member 12 is attached to the outer face of the second housing 20S. The second seal member 12 in the state of being fitted to the mating connector 60 is in intimate contact with the outer face of the second housing 20S and the inner face of the mating hood 63.

The electric wire cover 30 is made of synthetic resin. The electric wire cover 30 has cover locks 31, an electric wire pullout portion 32, and a cover face 36. The cover locks 31 are locked at the respective cover lock receivers 23 of the housing 20. The locking between the cover locks 31 and the cover lock receivers 23 fixes the electric wire cover 30 to the first housing 20F.

The electric wire pullout portion 32 extends rightward. The electric wire extends upward from the electric wire pullout face 21 of the housing 20, and is bent within the electric wire cover 30 and pulled out rightward along the electric wire pullout portion 32.

The cover face 36 covers the upper side of the electric wire pullout face 21 of the housing 20. The cover face 36 has a lever lock receiver 33, as shown in FIG. 3. The lever lock receiver 33 has a gap 34, which is formed in the cover face 36. The gap 34 is thin and elongated in the left-right direction.

The lever 40 assists in fitting to and separation from the mating connector 60 based on the principle of leverage. The lever 40 is made of synthetic resin. As shown in FIG. 2, the lever 40 includes a pair of left and right arms 41, an operable portion 42 connecting the two arms 41, and protrusions 49. The two arms 41 extend along the left and right faces of the outer wall 22. The two arms 41 face each other in the left-right direction.

Facing faces 43 of the two arms 41 each have a shaft hole 44 and a cam groove

45. The shaft hole 44 receive a corresponding one of the support shafts 24. The shaft hole 44 is a substantially circular hole extending through the corresponding arm 41 in the left-right direction. The lever 40 rotates between the first position and the second position about the support shafts 24 fitted to the shaft holes 44. The lever 40 that has rotated to the second position moves from the second position to a third position. The lever 40 is moved from the second position to the third position by pushing downward the lever 40 located at the second position. The direction of the movement from the second position to the third position is parallel with the Y-axis.

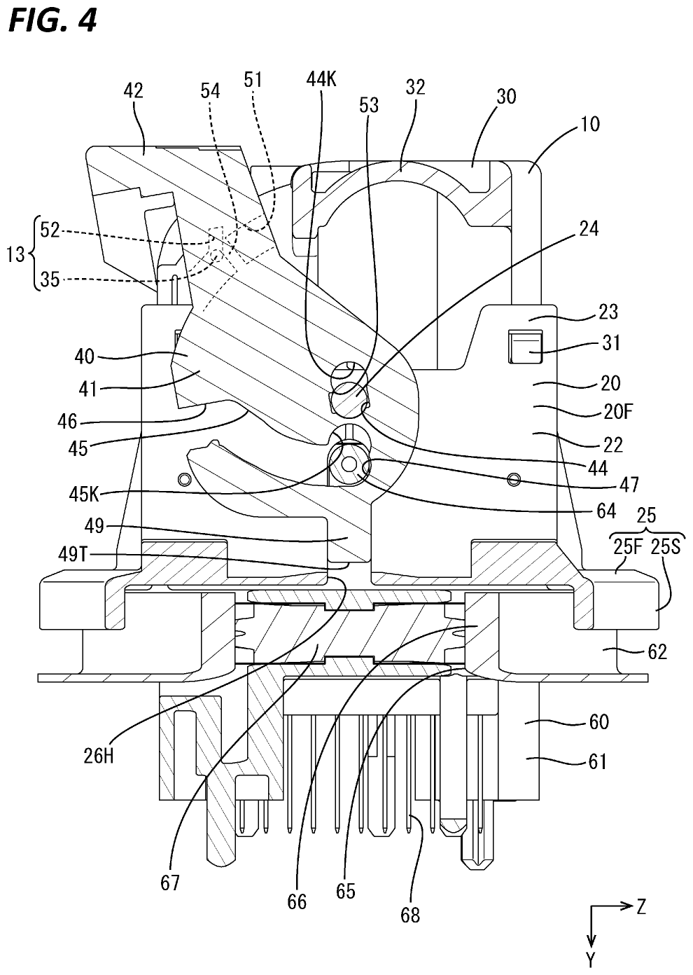

Each cam groove 45 receives a corresponding one of the cam pins 64, as shown in FIG. 4. The cam groove 45 has a cam entry 46 that allows the cam pin 64 to enter the cam groove 45. The cam groove 45 extends from the cam entry 46 to a cam deep end 47. The cam groove 45 curves from the cam entry 46 toward the cam deep end 47. When the lever 40 is at the first position, the cam entry 46 is connected to a corresponding one of the passage portions 26 in the left-right direction. The cam pins 64 of the mating housing 61 move from the through-holes 26H into the through-grooves 26M and the cam entries 46. When the lever 40 rotates, the cam pins 64 slide on groove faces of the cam grooves 45, allowing the connector 10 to be fitted to the mating connector 60.

As shown in FIG. 4, each shaft hole 44 has an extension 44K. The extension 44K of the shaft hole 44 is connected to the shaft hole 44. When the lever 40 is at the second position, the extension 44K expands upward from shaft hole 44. The extension 44K of the shaft hole 44 has a shape formed along the outer shape of the support shaft 24. A narrowed portion 53 that narrows the width in the front-rear direction is provided at a boundary between the shaft hole 44 and the extension 44K.

As shown in FIG. 4, each cam groove 45 has the extension 45K. When the lever 40 is at the second position, the extension 45K of the cam groove 45 expands upward from the cam deep end 47. The extension 45K has a shape conforming to the outer shape of the cam pin 64.

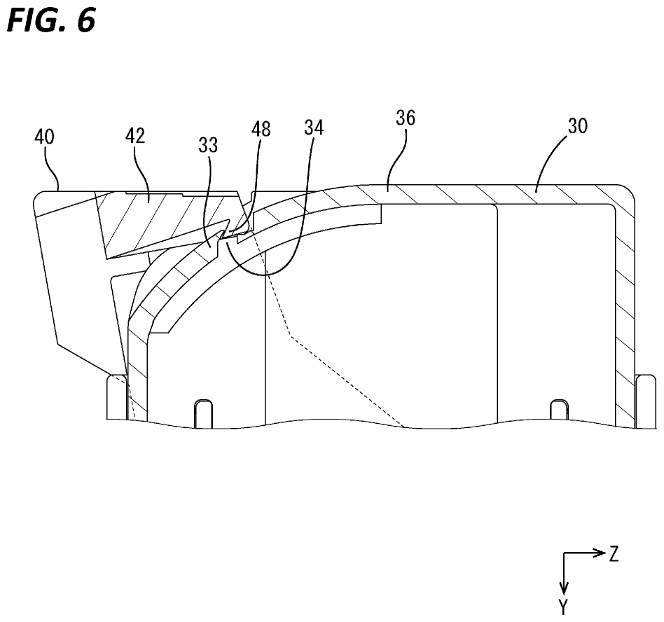

As shown in FIG. 3, the operable portion 42 has a lever lock 48. When the lever 40 is at the second position, the lever lock 48 protrudes downward from a lower face of the operable portion 42. When the lever 40 is at the third position, the lever lock 48 is located within the gap 34 in the lever lock receiver 33 (see FIG. 6). The lever lock 48 is locked at the lever lock receiver 33, and the lever 40 is restrained from moving from the third position to the second position and rotating from the second position to the first position.

The protrusions 49 protrude outward from outer faces of the arms 41, as shown in FIG. 2. When the lever 40 is at the second position, the protrusions 49 are located at the lower ends of the arms 41. Each protrusion 49 has a size with which the protrusion 49 can enter a corresponding one of the through-holes 26H. The protrusion 49 has a rectangular cross-sectional shape that blocks the through-hole 26H. “The protrusion 49 blocking the through-hole 26H” need not necessarily mean that the gap in the through-hole 26H is completely filled.

The connector 10 has a guide 13 that guides the movement from the second position to the third position. The guide 13 has a guide protrusion 35 provided in the electric wire cover 30, and a guide groove 52 provided in the lever 40.

As shown in FIG. 2, the guide protrusion 35 protrudes rightward from the right face of the electric wire cover 30. The guide protrusion 35 has a pin shape with a circular cross section. The guide protrusion 35 is provided rearward of the electric wire pullout portion 32.

The guide groove 52 is formed on the facing face 43 of the right arm 41. The guide groove 52 extends in the vertical direction when the lever 40 is at the second position. Front and rear edges of the guide groove 52 extend straight in the vertical direction. The guide groove 52 is continuous with a groove 51 formed in the facing faces 43 (see FIG. 4). The groove 51 has a raised portion 54 that the guide protrusion 35 can move over immediately before reaching the guide groove 52.

Next, an example of work to fit the connector 10 to the mating connector 60 is described. When starting fitting the connector 10 to the mating connector 60, the lever 40 is held at the first position, and the connector 10 and the mating connector 60 are shallowly fitted. Then, the cam pins 64 of the mating connector 60 enter the cam entries 46 through the through-holes 26H.

When the lever 40 is rotated from the first position to the second position, the mating connector 60 and the connector 10 are relatively attracted to each other by the cam action between the cam grooves 45 and the cam pins 64. When the lever 40 approaches the second position, the guide protrusion 35 enters the groove 51 in the facing faces 43. The guide protrusion 35 approaches the raised portion 54 immediately before the lever 40 reaches the second position. When the guide protrusion 35 moves over the raised portion 54, the lever 40 reaches the second position. A worker feels a resistance when the guide protrusion 35 moves over the raised portion 54. The worker can thus recognize that the lever 40 has moved to the second position.

When the lever 40 reaches the second position, the connector 10 and the mating connector 60 reach a normal fitting position, as shown in FIG. 4. At this time, the guide protrusion 35 is located immediately below the guide groove 52. The lever lock 48 is disposed immediately above the lever lock receiver 33 (see FIG. 3).

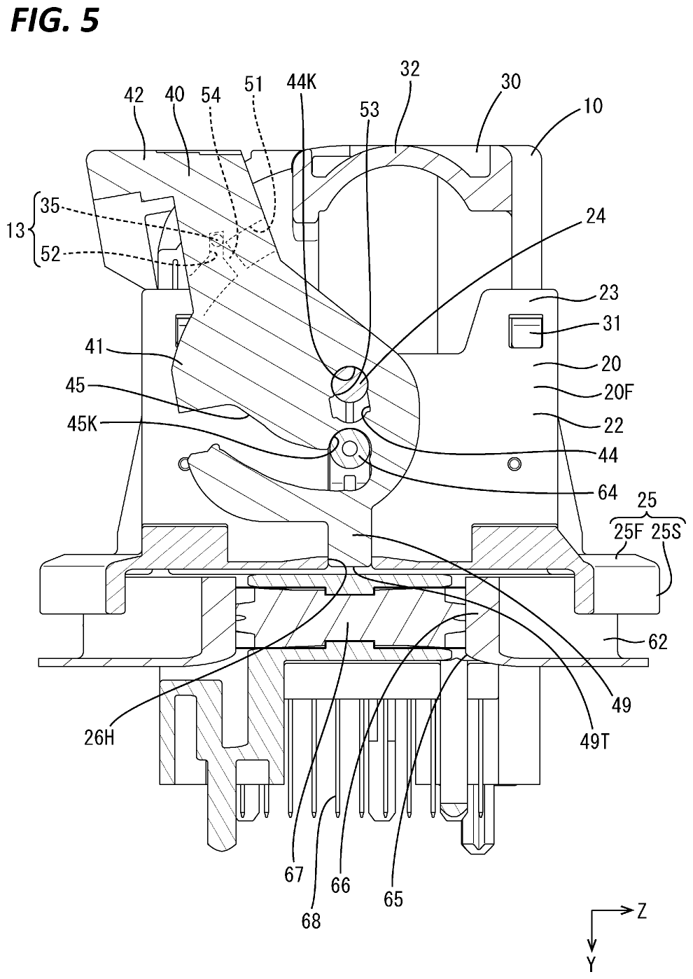

Next, the lever 40 is pushed from the second position to the third position. When the operable portion 42 of the lever 40 is pushed downward, the guide protrusion 35 enters the guide groove 52, as shown in FIG. 5. The movement of the lever 40 is guided by the contact between the guide protrusion 35 and the guide groove 52. The narrowed portions 53 of the shaft holes 44 move over the support shafts 24, the extensions 44K of the shaft holes 44 are fitted to the support shafts 24, and the extensions 45K of the cam grooves 45 are fitted to the cam pins 64. The worker feels a resistance when the narrowed portions 53 of the shaft holes 44 move over the support shafts 24. The worker can thus recognize that the lever 40 has moved to the third position.

When the lever 40 reaches the third position, protrusion end faces 49T of the protrusions 49 enter the through-holes 26H, as shown in FIG. 5. The dimension of the connector 10 in the vertical direction can be reduced by moving the lever 40 to the third position. The protrusions 49 that have entered the through-holes 26H block the through-holes 26H. As a result, the opening area of each through-hole 26H significantly decreases, thus making it difficult for water to enter between the tubular portion 66 of the case 62 and the mating housing 61 from the through-hole 26H. Further, when the lever 40 reaches the third position, the lever lock 48 engages with the lever lock receiver 33 (see FIG. 6). The gap 34 in the electric wire cover 30 is thus blocked. The work to fit the connector 10 to the mating connector 60 is completed as described above.

Next, the operation and effect of the example with the above-described configuration are described. The connector 10 includes the housing 20 and the lever 40. The lever 40 is rotatably attached to the housing 20. The lever 40 attracts the mating connector 60 by rotating from the first position to the second position. The housing 20 has the through-holes 26H for passing the cam pins 64 of the mating connector 60 through the cam grooves 45 formed in the arms 41 of the lever 40. The lever 40 can move from the second position to the third position. The lever 40 has the protrusions 49 that block the through-holes 26H when the lever 40 is at the third position. This configuration can make it difficult for water to enter the through-holes 26H for the cam pins 64, thus improving water resistance.

The direction of the movement from the second position to the third position is the same as the direction in which the connector 10 is fitted to the mating connector 60. The protrusions 49 enter the through-holes 26H when the lever 40 is at the third position. According to this configuration, the size of the connector 10 in the direction in which the connector 10 is fitted to the mating connector 60 can be made compact by placing the lever 40 at the third position.

The connector 10 includes the electric wire cover 30 that is attached to the housing 20. The electric wire cover 30 has the cover face 36 that covers the electric wire pullout face 21 of the housing 20. The lever 40 blocks the gap 34 formed in the cover face 36 when the lever 40 is at the third position. This configuration can make it less likely for the electric wire pullout face 21 to be exposed to water, thus improving water resistance.

The connector 10 has the guide 13 that guides the movement from the second position to the third position. According to this configuration, the lever 40 moves from the second position to the third position along the guide 13, and can thus easily move from the second position to the third position.

The mating connector 60 is fixed to the case 62 that is made of metal. The mating housing 61 has the mating hood 63 that can be fitted to the housing 20. The case 62 has the tubular portion 66 that covers the outer face of the mating hood 63. The housing 20 has the protruding wall 25 that covers the tubular portion 66. The through-holes 26H are formed in the protruding wall 25. This configuration can make it less likely for the case 62 to be exposed to water by blocking the through-holes 26H with the protrusions 49, thus preventing water from corroding the case 62.

### Other Embodiments of Present Disclosure

Note that the embodiment disclosed herein is illustrative in all respects and should not be considered restrictive.

In the above embodiment, the protrusions 49 enter the through-holes 26H; however, in another embodiment, the protrusions may only cover the through-holes, rather than entering the through-holes.

In the above embodiment, the gap 34 formed in the cover face 36 constitutes the lever lock receiver 33; however, in another embodiment, the gap in the cover face may be a gap that does not constitute the lever lock receiver.

In the above embodiment, the guide protrusion 35 is provided in the electric wire cover 30, and the guide groove 52 is provided in the lever 40; however, in another embodiment, the guide groove may be provided in the electric wire cover, and the guide protrusion may be provided in the lever. In yet another embodiment, the guide groove or the guide protrusion may be provided in the housing.

In the above embodiment, the lever 40 is rotatably attached to the housing 20; however, in another embodiment, the lever may be configured to slide straight relative to the housing.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A lever connector comprising:
a housing; and
a lever attached to the housing in a displaceable manner and configured to attract a mating connector by being displaced from a first position to a second position relative to the housing,
wherein the housing has a through-hole for passing a cam pin of the mating connector through a cam groove formed in an arm of the lever, and
the lever is movable from the second position to a third position after moving from first position to the second position relative to the housing, and has a protrusion that blocks the through-hole when the lever is at the third position.

2. The lever connector according to claim 1,
wherein a direction of the movement from the second position to the third position is the same as a direction in which the lever connector is fitted to the mating connector, and
the protrusion is located within the through-hole when the lever is at the third position.

3. The lever connector according to claim 1, further comprising:
an electric wire cover attached to the housing,
wherein the electric wire cover has a cover face covering an electric wire pullout face of the housing, and
the lever blocks a gap formed in the cover face when the lever is at the third position.

4. The lever connector according to claim 1, further comprising:
a guide for guiding the movement from the second position to the third position.

5. A connector device comprising:
the lever connector according to claim 1; and
a metal case to which the mating connector is to be fixed,
wherein the mating connector includes a mating housing, and the mating housing has a mating hood that is fittable to the housing,
the case has a tubular portion configured to cover an outer face of the mating hood,
the housing has a protruding wall covering the tubular portion, and
the through-hole is formed in the protruding wall.
